(19) United States
(12) Patent Application Publication
(10) Pub. No.: US 2009/0301098 A1
(43) Pub. Date: Dec. 10, 2009

(54) Method, device and system for efficeint energy transformation

(76) Inventor: Michael Abrahamsson, Vaxholm (SE)

Correspondence Address: SCHWEGMAN, LUNDBERG & WOESSNER, P.A., P.O. BOX 2938, MINNEAPOLIS, MN, 55402, US

(21) Appl. No.: 11/920,588

(22) PCT Filed: May 16, 2006
(86) PCT No.: PCT/SE2006/050123

§ 371 Date: Mar. 17, 2009

(30) Foreign Application Priority Data
May 19, 2005 (SE) 0501126-7

(51) Int. Cl. F02C 3/30

(52) U.S. Cl. 60/775; 60/39.53

(57) ABSTRACT

Method for efficient energy transformation by means of a gaseous medium comprising steam, said steam being produced from a first fluid medium, energy for heating the first fluid medium being provided by burning a fuel, comprising the steps of: mixing the steam with exhaust gas from combustion of said fuel; introducing said mixture into a cavity; and bringing said steam and exhaust gas mixture into contact with a cold second fluid medium within said cavity such that a supersonic shock wave is created. The invention also relates to a device and a system for efficient energy transformation by means of a gaseous medium comprising steam.

### TECHNICAL FIELD

The present invention relates to a method for efficient energy transformation by means of a gaseous medium comprising steam according to the preamble of claims 1 and 2. The present invention also relates to a device for efficient energy transformation by means of a gaseous medium comprising steam according to the preamble of claims 10 and 19. The present invention still further relates to a system for efficient energy transformation by means of a gaseous medium comprising steam according to the preamble of claim 11. The invention still further relates to a device for combusting a fuel according to the preamble of claim 23.

### BACKGROUND

WO 2005/012818 discloses a method, a device and a system for heating by means of a gaseous medium comprising steam, said steam being produced from water, energy for heating the water being provided by burning a fuel, wherein the steam is mixed with exhaust gas from the combustion of said gaseous medium; and wherein said mixture is used for heating purposes. A problem with the device in WO 2005/012818 is that it is difficult to achieve a complete combustion of the fuel.

### OBJECTS OF THE INVENTION

One object of the present invention is to provide a method for efficient energy transformation by means of a gaseous medium comprising steam, said steam being produced from a fluid medium, energy for heating the water being provided by burning a fuel, such that efficient energy transformation becomes more efficient.

Another object of the present invention is to provide a device and a system for efficient energy transformation by means of a gaseous medium comprising steam, said steam being produced from a fluid medium, energy for heating the water being provided by burning a fuel, such that efficient energy transformation becomes more efficient.

### SUMMARY OF THE INVENTION

These and other objects, apparent from the following description, are achieved by methods, a device and a system for efficient energy transformation by means of a gaseous medium comprising steam which is of the type stated by way of introduction and which in addition exhibits the features recited in the characterising clause of the appended claims 1, 2, 10, 11, 19 and 23. Preferred embodiments of the inventive methods, devices and systems are defined in appended sub claims 3-9, 12-18, 18, and 20-22.

By using oil as a fluid medium a more efficient energy carrier is achieved.

By bringing a cold medium into contact with a mixture of steam and exhaust gas facilitates creating a shockwave with a very high velocity, useful for energy transforming purposes.

By arranging the refractory member such that the flame of the burner is protected from the cooling effect of the fluid medium, the combustion efficiency is improved, i.e. residual deposits and dangerous gases are avoided as practically everything is combusted. In this way all of the cooling influence and undesired side effects on the flame are eliminated. Because of the heat reflecting capacities of the ceramic chamber walls, several beneficial results are achieved, such as: a significantly higher chamber temperature, a complete combustion, and extremely clean exhaust gases. This consequently increases the efficiency of the device.

Further advantageous embodiments are set out in the dependent claims.

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 shows a schematic and partly sectional view of a device for efficient energy transformation by means of a gaseous medium comprising steam according to a first embodiment of the present invention;

FIG. 2 shows a schematic elevational view of a system for efficient energy transformation by means of a gaseous medium comprising steam according to a second embodiment of the present invention;

FIG. 3 shows a schematic elevational view of a system for efficient energy transformation by means of a gaseous medium comprising steam according to a third embodiment of the present invention; and

FIG. 4 shows a schematic elevational view of a system for efficient energy transformation by means of a gaseous medium comprising steam according to a fourth embodiment of the present invention.

### DETAILED DESCRIPTION OF THE INVENTION

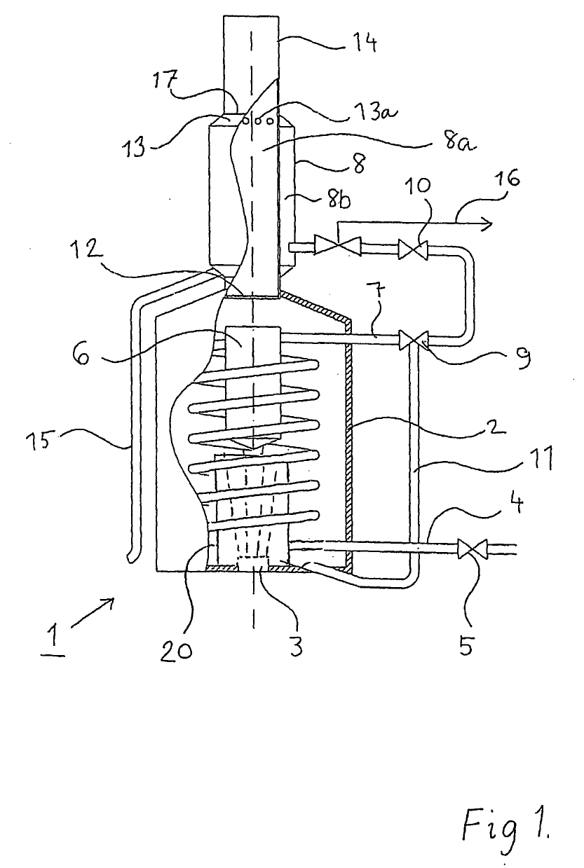

FIG. 1 shows a schematic and partly sectional view of a device for efficient energy transformation by means of a gaseous medium comprising steam according to a first embodiment of the present invention. The device 1 comprises a primary chamber 2, i.e. a combustion chamber, a burner 3 for burning said fuel, e.g. a gas burner 3, attached to the bottom of said chamber 2, for introducing heat into said chamber 2, and a fluid inlet 4a at the lower part of the chamber 2, for introducing fluid, e.g. water or oil, into a pipe 4, and a reducing valve 5 connected to the pipe 4, said pipe 4, when located inside the chamber 2, preferably having a helical shape rising upwardly in the chamber, and a steam chamber 6 to the upper part of which the pipe 4 is connected, in which steam chamber 6 water is intended to be introduced and boiled. The chamber further comprises an outlet 7, preferably a pipe 7, in the upper part of the steam chamber 6, and an injection chamber 8, to the inner cavity 8a of which the pipe 7, via a safety valve 9 and a vent passage 10, is connected, said valve 9 and passage 10 preferably being located outside of the chamber 2. The device further comprises an overflow pipe 11 connected to the safety valve 9, said pipe extending down back into the lower part of the chamber where it is arranged to put out the flame from the burner 3. The injection chamber 8 further has an outer cavity 8b surrounding the inner cavity 8a, said chamber 8 being attached to the top of the chamber 2. The device further comprises a flame guard 12, preferably a perforated plate or the like constituting the top of the chamber 2 and the bottom of the injection chamber 8. The steam is intended to be introduced into the inner cavity 8a of the injection chamber 8 via the pipe 7. The exhaust gas is intended to be introduced into the outer part 8b of the injection chamber 8 via the flame guard 12. The device further comprises a mixing chamber 13 constituting the upper part of the injection chamber, where steam, via openings 13a in the inner part 8a of the injection chamber 8, is intended to be introduced in the outer part 8b of the injection chamber 8, and a steam heating hose 14 or the like connected to the mixing chamber 13 via an opening 17. Steam and exhaust gases are thus intended to be mixed in the mixing chamber such that a steam and exhaust gas mixture, hereinafter referred to as steamex, is achieved. The device further comprises a drainage pipe 15 attached to the lower part of the inner part 8a of We injection chamber 8.

The device further comprises a member or wall 20, according to the present invention, comprising a refractory ceramic material, which member is arranged in the chamber 2 such that it surrounds the flame of the burner in its entire length, The refractory member preferably has an annular shape and is arranged to surround the flame as described above. The helically shaped pipe 4 is arranged to surround the refractory member 20 at a certain distance. The refractory member 20 has an axial height such that it almost reaches the steam chamber 6, the steam chamber 6 being arranged such that the top of the flame of the burner heats the bottom of said chamber 6.

In the combustion process about 40% of the generated gases are arranged to be guided upwards to baffle coils of the steam chamber 6 and to the mixing chamber. The remaining 60% are arranged to be guided downwards on the outside of the refractory ceramic member 20, between the refractory member and the helical pipe 4 to the bottom and guided around to the outside of the helical pipe 4 that partly acts as a feeder to the steam chamber 6, and partly as a cooler for the outside of the combustion chamber. Through this process a very stable temperature level is achieved in the combustion chamber.

The gases of combustion together with the preheated steam meet and mix in the mixing chamber. This mix contains 99.9% of the combustion energy, excluding any possible radiation losses. By mixing the steam and the gases generated by combustion a medium with extraordinary high energy content is attained. As the device, or steam generator, is equipped with all the necessary safety devices, pressure gauges and load regulators, exact temperature levelling as well as adjustment of relative levels and conditions of the steamex is made possible. Temperatures of the steamex of up to 600° C. and various properties may be generated.

A refractory member or wall such as described above in relation to FIG. 1 may be used in any combustion chamber, in order to increase the combustion efficiency.

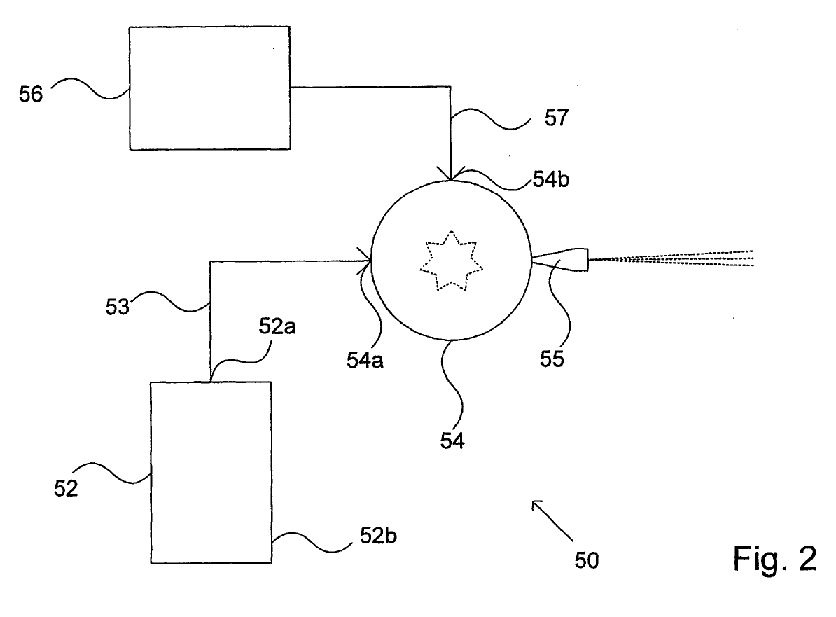

FIG. 2 shows a system 50 for efficient energy transformation by means of a gaseous medium comprising steam according to a second embodiment of the present invention, said steam being produced from a first fluid medium, energy for heating the fluid medium being provided by burning a fuel, where said fuel is constituted by a gaseous medium, for example butane, propane, natural gas or the like, or a liquid medium, for example diesel, oil or the like, or a solid medium, for example coal, pellets, peat, oilshale, coke, wood or the like, or a mixture thereof, and where said arrangement is intended to comprise any kind of unit, device, system, process plant, factory, engine or the like intended for burning a fuel, for example a gas burner, an oil burner, a turbine, a combustion engine, piston engine, an incinerator or the like including the device 1 according to FIG. 1 or similar, said system 50 comprising an arrangement for mixing the steam with exhaust gas from combustion of said fuel and means for introducing said mixture into a cavity 54, comprising an arrangement for bringing said mixture into contact with a second cold fluid medium such that a supersonic shockwave is created, and means for discharging a jet of fluid, created by means of said shock wave, through an opening 55 in said cavity 54.

The cavity preferably is a confined container 54, designed to withstand high pressure, having a first inlet 54a for introducing the steam and exhaust gas mixture, i.e. the steamex, a second inlet 54b for introducing the second fluid medium, and an outlet 55, the outlet preferably being a nozzle 55 or the like. The container 54 preferably has a substantially spherical shape. The arrangement or device 1, 52 is connected at an outlet 52a thereof to the first inlet 54a of the container 54 via a steamex supply line 53 through which the steamex is intended to be transferred. The second inlet 54b of the container 54 is connected via a fluid supply line 57 to a fluid reservoir 56 or the like, which may be anything which holds a liquid including the sea or a lake, from which reservoir 56 fluid is intended to be transferred via the fluid supply line 57 to the second inlet of the container The first fluid medium is intended to be introduced in an inlet 52b in the arrangement or device.

According to one aspect of the present invention the first fluid medium and the second fluid medium are cold water. In this case water can be supplied from the same source or separate sources.

According to another aspect of the present invention the first fluid medium is oil and the second fluid medium is water.

According to yet another aspect of the present invention the first and the second fluid medium is oil, wherein the oil can be supplied from the same source or separate sources.

According to a still further aspect of the present invention the first fluid medium is water and the second fluid medium is oil.

The first and second fluid medium could also be constituted by any suitable medium other than oil or water.

When operated steamex, produced in the device as described above and having a temperature of e.g. approximately 360° C. and a pressure of e.g. approximately 200 bar, is supplied in the steamex supply line 53 at a certain rate through the first inlet 54a of the container 54 and into the container 54. Substantially coincidentally the second cold fluid medium, having a temperature of e.g. approximately 15° C., is supplied in the fluid supply line 57 at a certain rate through the second inlet 54b of the container. When the cold medium is brought in contact with the steamex a shock wave occurs due to the liquid evaporation expansion, the shock wave having a propagation velocity of more than Mach 3. The container 54 is designed such, and the rate of the supplied steamex and the supplied cold second fluid medium is such that a jet of liquid is ejected through the outlet opening, e.g. nozzle, having a very high velocity, and a temperature of e.g. approximately 90° C. This system could be applied to e.g. drive a boat, where the created jet gives the driving force, and the sea water is used to supply the container with cold water.

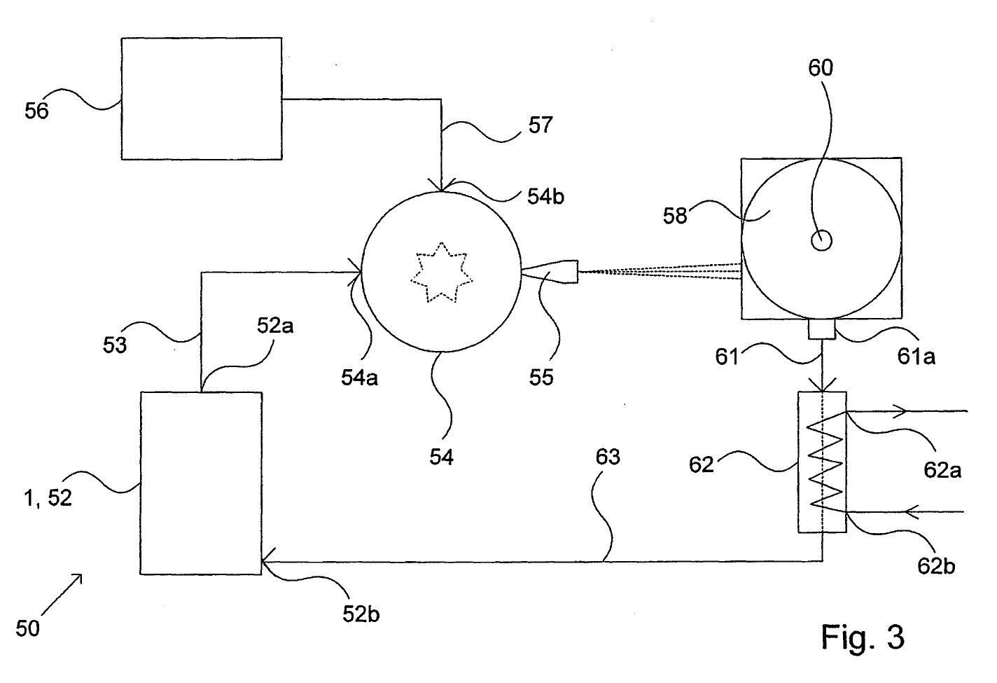

FIG. 3 shows a system according to a third embodiment of the present invention based on the system in FIG. 2, where the system further comprises a blade wheel 58, preferably a pelton wheel, arranged to receive the jet, and preferably arranged to rotate a shaft 60 by means of said jet. The shaft 60 could then for example be arranged to drive a generator or the like. The system 50 further comprises a heat exchanger 62 through which the liquid in the jet, after having transferred the energy to the blade wheel, is intended to flow in a supply line 61. The heat exchanger 62 comprises an inlet 62a into which a cold fluid, preferably water, is intended to flow, and an outlet 62b. The cold fluid is arranged to be heated by the liquid received from the blade wheel 58 as it passes through the heat exchanger. The supply line is preferably connected to the inlet of the steamex device 52 such that the fluid cooled down by means of the heat exchanger can be reused in the device. Preferably the fluid is intended to be filtered prior to be returned to the device 52. A pump may be arranged to pump the fluid back to the device 52. In the case when the first cold fluid medium and the second cold fluid medium are different from each other a separator 61a, for separating e.g. oil and water, is located downstream of the blade wheel.

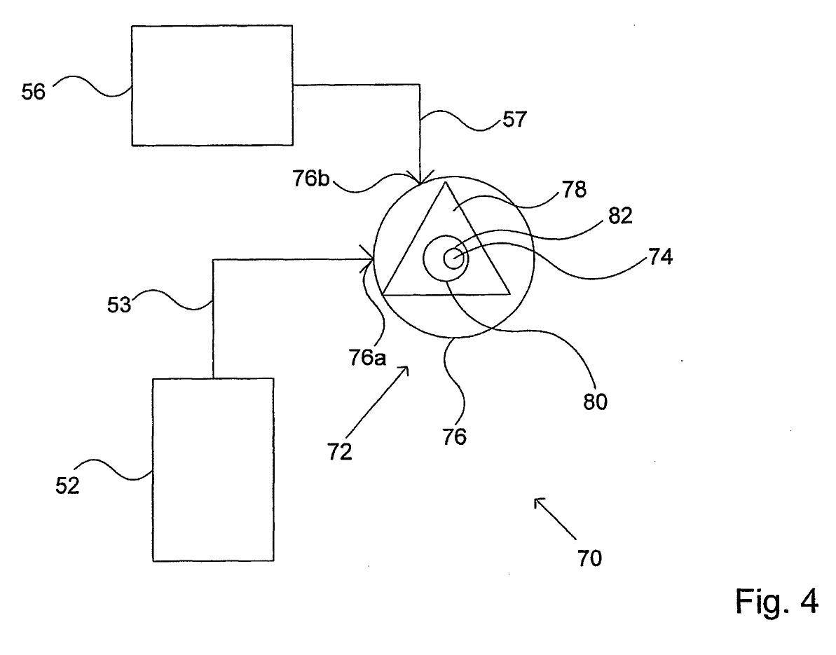

According to an alternative embodiment of the present invention the cavity into which the steamex and the cold fluid medium are introduced is a cavity in the housing of a wankel engine like configuration such that the condensation expansion occurs therein, i.e. using the wankel engine technique and rotating the shaft by means of the pressure caused by the condensation expansion. FIG. 4 shows a system 70 according to FIG. 2 where the container has been replace by the wankel engine like configuration 72. Preferably the wankel like engine 72 comprises a rotatable shaft 74, an about the rotatable shaft 74 concentrically arranged cylindrical housing 76, a rotor member 78 which is arranged to be rotated by the condensation expansion created by the introduction of steamex and the cold fluid medium in the first and second inlet respectively. The steamex and the cold fluid medium are transferred to and introduced in the first and second inlet in accordance with the description above relating to FIG. 2. The rotor member 78 may have a regular triangular shape or a hexagonal shape or any other suitable geometrical shape. The rotor member 78 is preferably arranged to be controlled by means of an, in the rotor symmetrically formed, internal gear teeth 80, which is arranged to be in permanent mesh with an, on the shaft arranged, external gear teeth 82, which in turn is arranged to be fixedly attached to the side of the housing 76. The rotor member 78 is eccentrically arranged relative to the shaft 74 and thus performs an eccentric motion when operated. The force is intended to be transferred via the rotor member 78, which preferably is eccentrically journalled in bearings, to an on the shaft 74 formed excenter.

There are several applications where the system 70 comprising the wankel engine lice configuration 72 may be used. For example for driving trains where the wankel engine like configuration 72 is intended to be arranged at, or rather constitute the, drive shaft of the train, such that the train is driven by means of the rotation of the rotor member 78 which is rotated by the force caused by the introduction of steamex and cold medium in the housing 76. The same solution may be applied to automobiles or other vehicles.

Where temperatures, pressures, efficiencies are mentioned they have been included for the purpose of increasing the intelligibility of the application and are only examples and do consequently not have any limiting effect on the interpretation of each element.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A method for efficient energy transformation by means of a gaseous medium comprising steam, said steam being produced from a first fluid medium, energy for heating the first fluid medium being provided by burning a fuel, comprising:
providing the steam from oil as the first fluid medium;
mixing the steam with exhaust gas from combustion of said fuel; and
using said mixture for energy transforming purposes.

2. A method for efficient energy transformation by means of a gaseous medium comprising steam, said steam being produced from a first fluid medium, energy for heating the first fluid medium being provided by burning a fuel, comprising:
mixing the steam with exhaust gas from combustion of said fuel;
introducing said mixture into a cavity; and
bringing said steam and exhaust gas mixture into contact with a cold second fluid medium within said cavity such that a supersonic shock wave is created.

3. The method according to claim 2, comprising discharging, by means of said shock wave, a jet of fluid through an opening of said cavity for energy transforming purposes.

4. The method according to claim 2, comprising rotating a shaft by means of said shock wave.

5. The method according to claim 4, wherein rotating said shaft includes directing the jet at a blade on a wheel.

6. The method according to claim 5, comprising:
exchanging heat between the fluid medium received, after the jet of fluid having passed through the wheel, and a third cold liquid medium; and
reusing the cold fluid medium for producing steam.

7. The method according to claim 6, comprising separating the first fluid medium from the second fluid medium, which is different than the first medium, prior to exchanging heat with the third fluid medium such that the first fluid medium can be reused.

8. The method according to claim 4, comprising rotating said shaft by means of a rotor member within a wankel cavity, and acting the shock wave on said rotor member such that it rotates.

9. The method according to claim 2, wherein said first fluid medium is oil or water, and wherein said second fluid medium is oil or water.

10. A device for efficient energy transformation by means of a gaseous medium comprising steam, said steam being produced from a first fluid medium, energy for heating the first fluid medium being provided by burning a fuel, said system comprising an arrangement for mixing the steam with exhaust gas from combustion of said fuel, wherein the first fluid medium is oil.

11. A system for efficient energy transformation by means of a gaseous medium comprising steam, said steam being produced from a first fluid medium, energy for heating the first fluid medium being provided by burning a fuel, said system comprising an arrangement for mixing the steam with exhaust gas from the combustion of said fuel and means for introducing said mixture into a cavity, characterised in an arrangement for bringing said mixture into contact with a second cold fluid medium within said cavity such that a supersonic shockwave is created.

12. The system according to claim 11, comprising means for discharging a jet of fluid, created by means of said shock wave, through an outlet (55) in said cavity (54; 76).

13. The system according to claim 11 comprising an arrangement for rotating a shaft by means of said shock wave.

14. The system according to claim 11, wherein said cavity includes a container comprising a first inlet for introducing the first fluid medium and a second inlet for introducing the second fluid medium.

15. The system according to claim 11, wherein said cavity is a confined pressure resistant container, the outlet being a nozzle for discharging said jet.

16. The system according to claim 13, wherein said arrangement for rotating the shaft comprises a blade wheel arranged to be rotated by means of said fluid jet, and wherein said wheel being arranged to rotate a shaft.

17. The system according to claim 13, wherein said arrangement comprises a rotor member eccentrically arranged about a shaft within the container in such a way that, when subjected to the force from the expansion of the shock wave, it rotates, said rotor member being arranged to rotate the shaft.

18. The system according to claim 11, wherein said first fluid medium is oil or water, and wherein said second fluid medium is oil or water.

19. A device for efficient energy transformation by means of a gaseous medium comprising steam, said steam being produced from a fluid medium, energy for heating the fluid medium being provided by burning a fuel, said system comprising an arrangement for mixing the steam with exhaust gas from combustion of said fuel, said device comprising a combustion chamber and a burner, said burner being arranged to heat the fluid medium in said combustion chamber, and refractory member for withstanding high temperatures arranged in said chamber such that the flame of the burner is protected from the cooling effect of the fluid medium, thus preventing the flame from being cooled.

20. The device according to claim 19, wherein the refractory member has a substantially annular shape and is arranged in said chamber such that it surrounds the entire length of the heat flame generated from the burner when operated.

21. The device according to claim 19, wherein the refractory member comprises a ceramic material having properties such that it withstands temperatures up to 2500° C.

22. The device according to claim 19, wherein a pipe configuration is arranged in said chamber for introducing said fluid medium and for extracting steam from said chamber wherein the burner is arranged to heat said first fluid medium in said pipe configuration, and means for extracting exhaust gases from combustion by means of said burner and means for mixing said steam and said exhaust gases, the refractory member being arranged relative to the pipe configuration such that the flame is protected from the cooling effect of the fluid medium in the pipe configuration, thus preventing the flame from being cooled.

23. A device for combusting a fuel comprising a combustion chamber and a burner, said burner being arranged to heat a fluid medium, in said combustion chamber, characterised in a refractory ceramic material for withstanding high temperatures arranged in said chamber such that the flame of the burner is protected from the cooling effect of the fluid medium, thus preventing the flame from being cooled.
